(19) United States
(12) Patent Application Publication
(10) Pub. No.: US 2021/0015135 A1
(43) Pub. Date: Jan. 21, 2021

(54) ENCAPSULATED MICRONUTRIENT GRANULES FOR FORTIFICATION OF EDIBLE SALT COMPOSITIONS

(71) Applicant: TATA CHEMICALS LIMITED, Mumbai (IN)

(72) Inventors: M.N. Shashikala, Pune (IN); Satyanarayana Reddy Jaggavarapu, Pune (IN); Pritam Jadav, Pune (IN); Nisha Singh, Pune (IN)

(73) Assignees: TATA CHEMICALS LIMITED, Mumbai (IN); TATA CONSUMER PRODUCTS LIMITED, Kolkata (IN)

(21) Appl. No.: 17/042,817

(22) PCT Filed: Mar. 27, 2019
(86) PCT No.: PCT/IB2019/052487

§ 371 Date: Sep. 28, 2020

(30) Foreign Application Priority Data
Mar. 29, 2018 (IN) 201821011987

(51) Int. Cl. A23L 27/40; A23P 10/35

(52) U.S. Cl. CPC A23L 27/40; A23V 2002/00; A23P 10/35

(57) ABSTRACT

Substantially encapsulated micronutrient granules for fortification of an edible salt composition are disclosed. Said encapsulated micronutrient granules comprise granules comprising 0.1 to 20% of at least one micronutrient and 1 to 99% of at least one binding agent selected from a group consisting of a fatty acid, cellulose derivative and sugar, encapsulated by an outer coating comprising a fatty acid and cellulose derivative.

### FIELD OF INVENTION

The present disclosure relates to fortified edible salt compositions. In particular, the present disclosure relates to a substantially encapsulated micronutrient granules for fortification of an edible salt composition.

### BACKGROUND

Iron and iodine are essential elements for the human body. Iron acts as a catalyst in the transport, storage and utilization of oxygen. Iron is found in hemoglobin, myoglobin, cytochrome and in other enzymes and iodine is an essential component of thyroid hormones.

Iron deficiency (anemia) and iodine deficiency disorders often coexist and affects more than one third of the world's population in the developing as well as industrialized nations, with serious consequences on mental and physical development. A food source fortified with iron and iodine can help to overcome such problems by ensuring a daily supply of these minerals.

Edible salt is an ideal food vehicle for such a fortification owing to its low cost and ubiquitous use. Iron and iodine fortified common salt can be used for the treatment of iron and/or iodine deficiency disorders. However, double fortification of salt with iron and iodine involves various problems. One such problem is catalytic reduction of iodate to iodine in presence of ferrous ions and oxygen which leads to sublimation of iodine and co-oxidation of ferrous to ferric leading to unacceptable color and sensorials in salt matrix. It is known that such problems can be overcome by encapsulating or chelating iron to create a physical barrier for the iodine source.

Zimmermann et al (Dual fortification of salt with iodine and microencapsulated iron: a randomized, double-blind, controlled trial in Moroccan schoolchildren. Am J Clin Nutr. 2003; 77:425-32.) have conducted randomized, double-blind, controlled trial in Moroccan schoolchildren, with double fortified salt that contained encapsulated ferrous sulphate with partially hydrogenated vegetable oil. There was unacceptable color development in salt with no significant organoleptic changes.

WO2002080706 discloses a food additive particle comprising a) an inorganic, porous core in which one or more water-soluble functional ingredients are impregnated, and b) a hydrophobic, water-insoluble outer coating having a melting point of greater than 100° C. and comprising one or more multivalent metal salts of fatty acids of chain length not less than 8.

US2017216216A1 provide particles of micronutrients and vitamins encapsulated within heat resistant pH-sensitive water-insoluble polymers, such as EUDRAGIT®, which are packaged within a salt shell.

However, encapsulation formulations developed so far are expensive and hence the price of double fortified salt is significantly higher and unlikely reaching the customers intended i.e lower income groups where both iron and iodine deficiency disorders are common. Further, the stability of both iron and iodine in such formulations is not very promising when it comes to long term storage. Such formulations also do not have good sensorial properties when added to many food matrixes.

Therefore, there is a need for an inexpensive fortified edible salt composition which has improved iron and iodine stability for long term storage. Further, there is a need for a simple process for preparing such a composition.

### SUMMARY

The present disclosure relates to a substantially encapsulated micronutrient granules for fortification of an edible salt composition. Said encapsulated micronutrient granules comprises granules comprising of 0.1 to 20% of at least one micronutrient and 1 to 99% of at least one binding agent selected from a group consisting of a fatty acid, cellulose derivative and sugar, encapsulated by an outer coating comprising of a fatty acid and cellulose derivative.

A fortified edible salt composition comprising of encapsulated micronutrient granules is also disclosed. Said fortified edible salt composition comprises of 98% of an edible salt; 0.1 to 5% of the above encapsulated micronutrient granules; and 0.01 to 0.5% of an additional micronutrient selected from a group consisting of potassium iodate, potassium iodide, and mixtures thereof.

The present disclosure also relates to a process for preparing substantially encapsulated micronutrient granules. Said process comprises forming granules comprising of 0.1 to 20 of at least one micronutrient and 1 to 99% of at least one binding agent selected from a group consisting of a fatty acid, cellulose derivative and sugar; and coating said granules with an outer coating comprising of a fatty acid and cellulose derivative to obtain said encapsulated micronutrient granules.

### BRIEF DESCRIPTION OF FIGURES

FIG. 1 shows the Scanning Electron Microscopic (SEM) image of uncoated (after spheronization) iron granules, obtained in accordance with an embodiment of the present invention.

FIG. 2 shows the Scanning Electron Microscopic (SEM) image of coated iron granules, obtained in accordance with an embodiment of the present invention.

FIG. 3 shows the change in iodine content in substantially encapsulated iron granules obtained in accordance with an embodiment of the present invention, over a period of time.

FIG. 4 illustrates the release profile of 200 mg of substantially encapsulated iron granules (iron content: 10 to 10.5%) obtained in accordance with an embodiment of the present invention in (i) 100 ml of distilled water and (ii) water having pH 2, under stirring at 100 rpm.

FIG. 5 illustrates the release profile of 200 mg of substantially encapsulated iron granules (iron content: 10 to 10.5%) obtained in accordance with an embodiment of the present invention in (i) 100 ml of distilled water and (ii) water having pH 2, without stirring.

FIG. 6 shows the result of preference test (comparision between fortified edible salt composition in accordance with an embodiment of the present invention and control iodized salt) on the basis of colour.

FIG. 7 shows the result of preference test (comparision between fortified edible salt composition in accordance with an embodiment of the present invention and control iodized salt) on the basis of taste.

FIG. 8 shows the result of preference test (comparision between fortified edible salt composition in accordance with an embodiment of the present invention and control iodized salt) on the basis of aroma.

FIG. 9 shows the result of preference test (comparision between fortified edible salt composition in accordance with an embodiment of the present invention and control iodized salt) on the basis of overall acceptability.

### DETAILED DESCRIPTION

For the purpose of promoting an understanding of the principles of the disclosure, reference will now be made to embodiments and specific language will be used to describe the same. It will nevertheless be understood that no limitation of the scope of the disclosure is thereby intended, such alterations and further modifications in the disclosed composition and method, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment” “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

In its broadest scope, the present disclosure relates to fortified edible salt compositions. In particular, the present disclosure relates to a substantially encapsulated micronutrient granules for fortification of an edible salt composition. Said substantially encapsulated micronutrient granules comprises granules comprising of 0.1 to 20% of at least one micronutrient and 1 to 99% of at least one binding agent selected from a group consisting of a fatty acid, cellulose derivative and sugar, encapsulated by an outer coating comprising of a fatty acid and cellulose derivative.

Herein, binding agent selected from a group consisting of a cellulose derivative, sugar and fatty acid acts as a moisture barrier coating. In accordance with an embodiment, said granules comprise 1 to 99% of at least one binding agent, and preferably 60 to 90% of at least one binding agent.

In accordance with an embodiment, said fatty acid is any fatty acid, which has essentially long hydrocarbon chains containing a carboxyl group at one end and a methyl group at the other. Said fatty acids may be obtained from hydrogenated vegetable or animal oils and are around C₁₆-C₂₀ in length. In accordance with an embodiment, fatty acid is selected from a group consisting of stearic acid, palmitic acid, salts of stearic acid, soy sterene and the like. In accordance with a preferred embodiment, fatty acid is stearic acid.

In accordance with an embodiment, cellulose derivative is selected from a group consisting of hydroxyl propyl methyl cellulose (HPMC), hydroxyl ethyl cellulose, hydroxyl methyl cellulose, microcrystalline cellulose, ethyl cellulose and family thereof. In accordance with a preferred embodiment, said cellulose derivative is hydroxyl propyl methyl cellulose.

In accordance with an embodiment, said sugar is selected from a group consisting of fructose, glucose, mannitol, sorbitol, sucrose and family thereof, and is preferably sucrose.

In accordance with an embodiment, said granules comprise 0.1 to 20% of at least one micronutrient, and preferably 5 to 18% of at least one micronutrient.

In accordance with an embodiment, the micronutrient is selected from a group consisting of Fe source, Zn source and mixtures thereof, and preferably Fe source. In accordance with an embodiment, said Fe source is a food grade iron containing compound selected from a group consisting of ferrous sulphate heptahydrate, ferrous fumarate, ferrous citrate and mixtures thereof, and is preferably ferrous sulphate hepta hydrate. In accordance with an embodiment, said Zn source is selected from a group consisting of zinc sulphate, zinc gluconate, zinc oxide, zinc stearate.

In accordance with an aspect, outer coating comprising of a fatty acid and cellulose derivative. Fatty acid acts as a moisture barrier and cellulose derivatives improves the wettability and spreadability of fatty acid. In accordance with an embodiment, the outer coating comprises the fatty acid and cellulose derivative in a ratio ranging between 5:1 to 1:5, and preferably between 3:1.

In accordance with an embodiment, said fatty acid is selected from a group consisting of stearic acid, palmitic acid, salts of stearic acid, soy sterene and the like, and preferably stearic acid. In accordance with an embodiment, said cellulose derivative is selected from a group consisting of hydroxyl propyl methyl cellulose, hydroxyl ethyl cellulose, hydroxyl methyl cellulose, microcrystalline cellulose, ethyl cellulose and family thereof, and preferably hydroxyl propyl methyl cellulose.

In accordance with an embodiment, the outer coating comprises of one or more consecutive layers of fatty acid and cellulose derivative. In accordance with an alternate embodiment, the outer coating comprises of one or more layers of a blend of the fatty acid and cellulose derivative. In accordance with a preferred embodiment, the outer coating comprises of a blend of the fatty acid and cellulose derivative. In accordance with an embodiment, the outer coating further comprises of an emulsifier. Said emulsifier comprises 10 to 1000 ppm of polysorbate 80.

In accordance with an embodiment, said substantially encapsulated micronutrient granules have a particle size in a range of 200 to 800 microns, and preferably 300 to 600 microns.

The present disclosure also relates to a process for preparing substantially encapsulated micronutrient granules. Said process comprises:
forming granules comprising 0.1 to 20% of at least one micronutrient and 1 to 99 of at least one binding agent selected from a group consisting of a cellulose derivative, sugar and fatty acid.
coating said granules with an outer coating comprising of a fatty acid and cellulose derivative to obtain said encapsulated micronutrient granules.

In accordance with an aspect, the disclosed process comprises a first step of granulation, followed by a second step of encapsulation. The process of granulation consists of blending micronutrient with the binding agent and granulation of the same to required size ranging between 200 to 800 microns, and preferably 300 to 600 microns. In accordance with an embodiment, granulation is carried out by a method selected from a group consisting of high shear granulation, direct compression binding and extrusion spheronization method. After granulation, the obtained granules are dried at a temperature ranging between 30 to 70° C. and preferably between 45 to 60° C.

In accordance with an embodiment, the outer coating is applied such that it comprises fatty acid and cellulose derivative in a ratio ranging between 5:1 to 1:5, and preferably 3:1. In accordance with an embodiment, the outer coating is formed by coating the granules with one or more consecutive layers of fatty acid and cellulose derivative. In accordance with an alternate embodiment, the outer coating is formed by coating one or more layers of a blend of fatty acid and cellulose derivative. In accordance with a preferred embodiment, the outer coating comprises of a blend of fatty acid and cellulose derivative.

In accordance with an embodiment, fatty acid is selected from a group consisting of stearic acid, palmitic acid, salts of stearic acid, soy sterene, and preferably stearic acid. In accordance with an embodiment, fatty acid is melted or dissolved in an organic solvents. Said organic solvent is preferably ethanol. Fatty acid, in particular, stearic acid for the purposes of present invention may be obtained from any known commercial sources. In accordance with an embodiment, a blend of fatty acid and cellulose derivative is prepared by in aqueous medium or ethanol-water binary mixture.

In accordance with an embodiment, said cellulose derivative is selected from a group consisting of hydroxyl propyl methyl cellulose, hydroxyl ethyl cellulose, hydroxyl methyl cellulose, microcrystalline cellulose, ethyl cellulose and family thereof, and preferably hydroxyl propyl methyl cellulose. Cellulose derivatives, in particular, hydroxyl propyl methyl cellulose for the purpose of present invention may be obtained from any known commercial sources, such as Dow, Ashland or any local manufacturer.

In accordance with an embodiment, encapsulation of dried granules with outer coating was carried out in fluid bed coating unit. Alternatively, encapsulation of dried granules with outer coating can be carried out in wurster coating unit. The granules are uniformly coated by adjusting the viscosity, wettability and ratio of fatty acid and cellulose derivative.

The present disclosure also relates to a fortified edible salt composition. Said fortified edible salt composition comprises:
98% of an edible salt;
0.1 to 5% of disclosed substantially encapsulated micronutrient granules; and
0.01 to 0.5% of an additional micronutrient selected from a group consisting of potassium iodate, potassium iodide, and mixtures thereof.

In accordance with an embodiment, said edible salt includes but is not limited to NaCl, KCl or mixtures thereof. In accordance with an embodiment, both solar dried salt and vacuum evaporated salt can be fortified with using the disclosed substantially encapsulated micronutrient granules.

In accordance with an embodiment, the micronutrient is present in a concentration between 100 to 2000 ppm in the fortified edible salt composition.

Any known process of preparing a fortified edible salt composition can be used. In particular, said fortified edible salt composition are prepared by blending the substantially encapsulated micronutrient granules with NaCl salt.

### EXAMPLES

### Example 1: Preparation of Substantially Encapsulated Iron Granules

200 grams of Ferrous sulphate heptahydrate was taken and finely powdered. Hydroxyl propyl methyl cellulose (HPMC) grade K4M (2.5%), adequate amount of sucrose solution was added and mixed till dough like consistency was reached. It was then passed through 52 mesh sieve, and spheronized to get granules of 300 to 500 microns. These granules were dried in an oven at 50° C.

Encapsulation of the obtained granules was done on lab model Unifluid mini fluid bed dryer of 250 grams capacity. 200 grams of granules were loaded into the fluid bed dryer. 50 grams of Stearic acid (25% of weight of granules) was dissolved in 150 ml of ethanol and maintained at 60 to 75° C. Top spray coating method was done to encapsulate the granules. Peristaltic pump tube that carries the solution was insulated to avoid solidification of stearic acid due to drop in temperature. Atomization air pressure was kept at 1 to 2 bar. Inlet air flow was at 2000 to 3000 cfm and product temperature was maintained at 40 to 45° C. Fluidization was continued for 10 more minutes to completely evaporate ethanol so that the end product is devoid of any traces of ethanol.

The above encapsulated granules were further coated with 2% of HPMC at room temperature and product temperature 42 to 45° C. The encapsulated iron granules thus produced was observed to be white to light yellow in color. Iron content in the premix was found to be 19 to 20%. Increase in iron content was observed due to loss of hydration.

### Example 2: Preparation of Substantially Encapsulated Iron Granules

200 grams of Ferrous sulphate heptahydrate and 40 grams of sucrose were taken and finely powdered. HPMC grade K4M (2.5%) was added and mixed till dough like consistency was reached. It was then passed through 52 mesh sieve, and spheronized to get granules of 300 to 500 microns. These granules were dried in an oven at 50° C.

Encapsulation of the obtained granules was done on lab model Unifluid mini fluid bed dryer of 250 grams capacity. 200 grams of granules were loaded into the fluid bed dryer. 50 grams of Stearic acid (25% of weight of granules) was dissolved in 150 ml of ethanol and maintained at 60 to 75° C. Top spray coating method was done to encapsulate the granules. Peristaltic pump tube that carries the solution was insulated to avoid solidification of stearic acid due to drop in temperature. Atomization air pressure was kept at 1 to 2 bar. Inlet air flow was at 2000 to 3000 cfm and product temperature was maintained at 40 to 45° C. Fluidization was continued for 10 more minutes to completely evaporate ethanol so that the end product is devoid of any traces of ethanol.

The above granules were further coated with 2.5% of HPMC at room temperature and product temperature 42 to 45° C. The encapsulated iron granules thus produced is white to light yellow in color. Iron content in the premix was found to be 18 to 19%.

### Example 3: Preparation of Substantially Encapsulated Iron Granules

1000 grams of Ferrous sulphate heptahydrate and 200 grams of sucrose were taken and blended to finely powder. HPMC grade K4M (2.5%) was added and mixed till dough like consistency was reached. It was then passed through extruder and spheronizer to get 300 to 800 micron size granules. These granules were dried in an oven at 50° C. Iron content in the granules was found to be 18%.

Encapsulation of above granules was done on Unifluid-W, bottom spray Wurster coater of capacity 1.5 Kg. 800 grams of granules were loaded into the fluid bed dryer. 200 gms of stearic acid (25% of weight of granules) was coated by adopting method of hot melt coating with lipid excipients. Stearic acid was melted and maintained at temperature 90° C. Bottom spray coating method was done to encapsulate the granules. Peristatic pump tube that carried the solution was insulated and heated to avoid solidification of stearic acid due to drop in temperature. Atomization air pressure was kept at 1 to 2 bar. Atomization temperature was maintained at 120° C. Inlet air flow was maintained at 2000 to 2500 cfm and product temperature was maintained at 40 to 45° C. Fluidization was continued for 15 more minutes to completely dry the samples.

Stearic acid encapsulated granules were further coated with HPMC and iron content of encapsulated iron granules was found to be in the range of 14 to 15%.

### Example 4: Preparation of Substantially Encapsulated Iron Granules

116 grams of Ferrous sulphate heptahydrate and and 28 grams of sucrose were taken and finely powdered. 28 grams of HPMC grade E5, 14 grams of stearic acid, and sugar solution were added and mixed till dough like consistency was reached. It was then passed through an extruder with 52 mesh sieve, and spheronized for 2 minutes to get granules of 300 to 500 microns. These granules were dried in an oven at 50° C.

For encapsulation of above obtained granules, 10 grams of HPMC grade E5 was dispersed in 100 grams of water. 15 grams of stearic acid was dissolved in 75 grams of ethanol at 70° C. Polysorbate 80, 200 mg was added as an emulsifier. Dissolved stearic acid (STA) solution was slowly added to HPMC solution slowly under constant stirring. This solution was cooled slowly and stirring was continued for 2 hours to get uniform dispersion of STA particles in water-ethanol solution. Coating of granules was carried out with this solution. Encapsulation was done on lab model Unifluid mini fluid bed dryer of 250 grams capacity. 100 grams of granules were loaded into the fluid bed dryer. Wurster technology based bottom spray coating method was done to encapsulate the granules. Atomization air pressure was kept at 1 to 2 bar and spray rate was 2 ml/minute. Inlet air flow was maintained at 2000 to 3000 cfm and product temperature was maintained at 40 to 45° C. Fluidization was continued for 10 more minutes to completely evaporate ethanol such that the end product is devoid of any traces of ethanol.

Above process of encapsulation was repeated to repeat the coating and increase the barrier. Iron content in dried granules was found to be 11 to 12%.

### Example 5: Preparation of Substantially Encapsulated Iron Granules

62 grams of ferrous sulphate heptahydrate, 1.0 grams of stearic acid and 13 grams of each HPMC grade E5 and 13 gms sucrose were added and mixed at room temperature by adding required amounts of sugar solution to get dough like consistency. This was passed through an extruder at 60 rpm through 0.5 mm mesh size. The extruder was spheronized for required amount of time to get uniform granules of spherical shape. Granules were then sieved to the required size of 300 to 500 microns.

For encapsulation of 100 grams of above granules, aqueous based solution was prepared as follows. 7.5 grams of stearic acid was melted at 70 C and 20 mg of polysorbate 80 was added under continuous stirring. 2.5 grams of HPMC E5 was dispersed in 100 grams was water and heated to 70 C. Dissolved HPMC solution was added to melted stearic acid solution drop by drop under continuous stirring. Solution was brought down to room temperature under continuous stirring. Stable, uniform solution was obtained that was coated in lab model bottom spray coating unit.

Above process of encapsulation was repeated to impart uniform coating and increase the barrier. Iron content in dried granules was found to be 11 to 12%.

### Example 6: Preparation of Substantially Encapsulated Iron Granules

305 grams of ferrous sulphate heptahydrate, 5 grams of stearic acid and 65 grams of each HPMC grade E5 and sucrose were added and mixed at room temperature by adding required amounts of sugar solution to get dough like consistency. This was passed through an extruder at 60 rpm through 0.5 mm mesh size. The extruder was spheronized for required amount of time to get uniform granules of spherical shape. Granules were then sieved to the required size of 300 to 500 microns.

For encapsulation of 100 grams of above granules, aqueous based solution was prepared as follows. 7.5 grams of stearic acid was melted at 70 C and 20 mg of polysorbate 80 was added under continuous stirring. 2.5 grams of HPMC E15 was dispersed in 100 grams of water and heated to 70 C. Dissolved HPMC solution was added to melted stearic acid solution drop by drop under continuous stirring. Solution was brought down to room temperature under continuous stirring. Stable, uniform solution was obtained that was coated in lab model bottom spray coating unit. Coating was repeated till the coating was uniform confirmed from microscopic observation.

Above process of encapsulation was repeated to impart uniform coating and increase the barrier. Iron content in dried granules was found to be 11 to 12%.

### Example 7: Preparation of Substantially Encapsulated Iron Granules

305 grams of ferrous sulphate heptahydrate, 5 grams of stearic acid and 65 grams of each HPMC grade E5 and sucrose were added and mixed at room temperature by adding required amounts of sugar solution to get dough like consistency. This was passed through an extruder at 60 rpm through 0.5 mm mesh size. The extruder was spheronized for required amount of time to get uniform granules of spherical shape. Granules were then sieved to the required size of 300 to 500 microns.

For encapsulation of above granules, 50 grams of HPMC grade E5 was dispersed in 500 grams of water. 100 grams of stearic acid was dissolved in 350 grams of ethanol at 70° C. Polysorbate 80 (1 gram) was added as emulsifier Dissolved stearic acid (STA) solution was slowly added to HPMC solution under constant stirring. This solution was cooled slowly while stirring was continued for 2 hours to get uniform dispersion of STA particles in water-ethanol solution. Coating of granules was carried out with this solution. Encapsulation was done on 2 Kg capacity Wruster technology based bottom spray coating unit. Atomization air pressure was kept at 1 to 2 bar with solution sprayed at rate 2 ml/minute. Inlet air flow was maintained at 2000 to 3000 cfm and product temperature was maintained at 40 to 45° C. Fluidization was continued for 10 more minutes to completely evaporate ethanol such that the end product is devoid of any traces of ethanol.

For uniform coating and to ensure moisture barrier coating was repeated. Iron content in dried granules was found to be 10 to 12%.

### Example 8: Preparation of Substantially Encapsulated Iron Granules

610 grams of ferrous sulphate, 10 grams of stearic acid and 130 grams of each HPMC E5 and Sucrose were added and mixed at room temperature by adding required amounts of sugar solution to get dough like consistency. This was passed through extruder at 60 rpm through 0.5 mm mesh size. The extruder was spheronized for required amount of time to get uniform granules of spherical shape. Granules were then sieved to the required size of 300 to 500 microns.

For encapsulation of above granules, 90 grams of HPMC grade E5 was dissolved in 1000 grams of water. Further, 300 grams of stearic acid was dissolved in 1000 grams of ethanol at 70° C. 2 grams of Tween 80 was added to aid the uniform dispersion of stearic acid in water-ethanol binary mixture. Dissolved stearic acid (STA) solution was slowly added to HPMC solution under constant stirring. This solution was cooled slowly and stirring was continued for 2 hours to get uniform dispersion of STA particles in water-ethanol solution. Coating of granules was carried out with this solution. Encapsulation was done on 2 Kg capacity Wruster technology based bottom spray coating unit. Atomization air pressure was kept at 1 to 2 bar with solution spray rate of 2 ml/minute. Inlet air flow was maintained at 2000 to 3000 cfm and product temperature was maintained at 40 to 45° C. Fluidization was continued for 10 more minutes to completely evaporate ethanol such that the end product is devoid of any traces of ethanol.

For uniform coating and to ensure moisture barrier, coating was repeated. Iron content in dried encapsulated iron granules was found to be 10 to 12%.

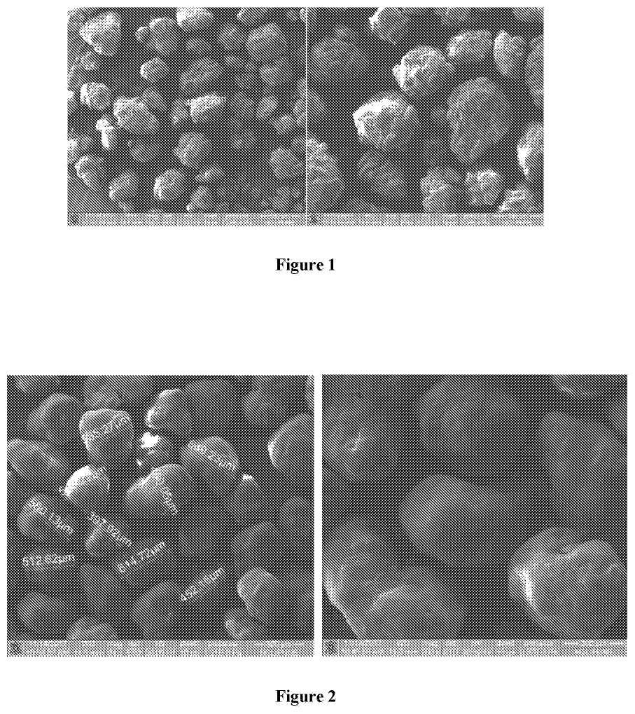

Table 1 lists the characteristics of obtained substantially encapsulated iron granules. FIGS. 1 and 2 show the Scanning Electron Microscopic (SEM) image of uncoated (after spheronization) and coated iron granules respectively.

TABLE 1

| | |
|---|---|
| Density | 0.75 to 0.8 g/ml |
| Moisture | 4 to 5% |
| Iron Content | 10 to 11% |
| Color | Off white |

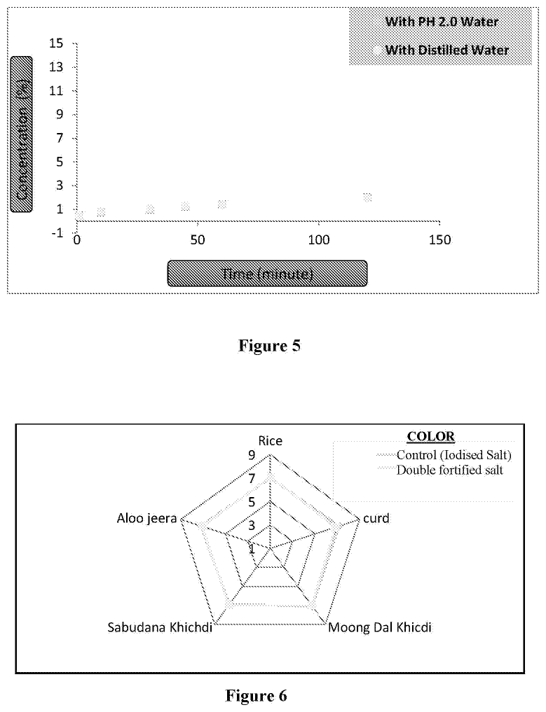

FIGS. 4 and 5 illustrates the release profile of 200 mg of substantially encapsulated iron granules (iron content: 10 to 10.5%) obtained in accordance with an embodiment of the present invention in (i) 100 ml of distilled water and (ii) water having pH 2, under stirring at 100 rpm and without stirring respectively.

### Example 9: Preparation of Fortified Edible Salt Composition

Substantially encapsulated iron granules, in accordance with an embodiment of the present disclosure, that is off white in color, with iron content of 14 to 15% was taken. Said encapsulated iron granules was added to 1 Kg of iodized salt such that the iron content in salt is >850 ppm as required by FSSAI guide lines. Iodine stability and color of salt was monitored over a period of 5 months at ambient temperature and humidity. It was observed that Iodine remains stable in salt and said encapsulated iron granules have developed light brown color.

### Example 10: Preparation of Fortified Edible Salt Composition

50 Kg of iodised salt with iodine content of 45 ppm was taken and encapsulated iron granules, in accordance with an embodiment of the present disclosure, with iron content 14 to 15% was blended such that the iron content in salt is 1000 ppm. Blending was done in a V cone blender by series dilution to obtain uniform incorporation of iron in salt. Three samples were picked from this batch for analysis of iodine and iron. Iodine was present at 40 to 42 ppm and iron was present at 950 to 990 ppm.

Iodine was found to be stable over a period of 5 months, but encapsulated iron granules had developed light brown color that is not acceptable to consumers.

### Example 11: Preparation of Fortified Edible Salt Composition

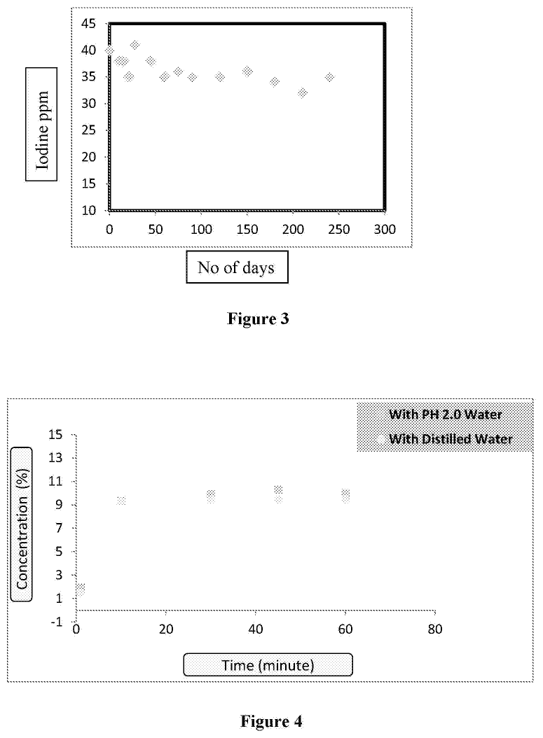

1 Kg Non-iodized salt was taken and KIO₃ was added to obtain 40 ppm of iodine. Silica was added as anticaking agent. To this, encapsulated iron granules with iron content of 10 to 12% was added to give iron content of >850 ppm. Iodine was monitored over a period of time. Color of the encapsulated iron granules and iodine are stable over a period of 8 months as shown in FIG. 3.

### Example 12: Preparation of Fortified Edible Salt Composition

200 Kg of vacuum evaporated salt was taken and KIO₃ was added in geometric progression to obtain 40 ppm of iodine. Silica was added as anticaking agent. To this, encapsulated iron granules with iron content of 10 to 12% was added to give iron content of >850 ppm. Iodine was monitored over a period of time. Color of the encapsulated iron granules and iodine was found to be stable over a period of more than (shelf life studies under progress) 5 months.

### Example 13: Preparation of Fortified Edible Salt Composition

200 Kg of solar evaporated iodized salt was taken. Silica was added as anticaking agent. To this, encapsulated iron granules with iron content of 10 to 12% was added to give iron content of >850 ppm. Iodine was monitored over a period of time. Color of the encapsulated iron granules and iodine was found to be stable over a period of more than (shelf life studies under progress) 5 months.

Sensory evaluation: Preference test was carried out to determine preference for double fortified salt in accordance with an embodiment of the present invention vis-à-vis control iodised salt (available in market). The food prepared using the inventive and control salt was rated using 9 point hedonic scale. Rating on the basis of colour, aroma, taste and over all acceptability.
1. Rice: 100 grams of rice was cooked in 200 ml of water in a pressure cooker with 2 grams of salt, and was served for tasting.
2. Jeera aloo: Jeera aloo was prepared using 2 grams of salt and served for tasting.
3. Sabudana (Sago) Khichdi: Sabudana Khichdi was prepared using 2.5 grams of salt and served for tasting.
4. Moong Khichdi: Moong Khichdi was prepared using 3 grams of salt, and served for tasting.
5. Curd: 1% salt was added in curd and served for tasting.

### Observation:

Colour: No perceivable change was found in the color of food prepared using inventive double fortified salt and control iodised salt as rated by assessors. The result of preference test on the basis of colour is shown in FIG. 6.

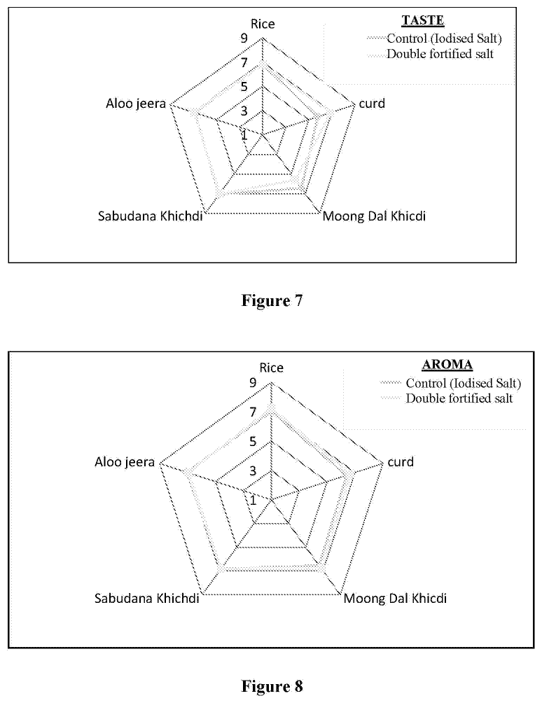

Taste: On the basis rating for taste, rice, sabudana khichdi and aloo jeera prepared using inventive double fortified salt and control iodised salt has similar scores. Whereas mild variation was observed in Moong dal khicdi and curd by the assessors. The result of preference test on the basis of taste is shown in FIG. 7.

Aroma: No perceivable change was found in the aroma of food prepared using inventive double fortified salt and iodised salt as rated by assessors. The result of preference test on the basis of aroma is shown in FIG. 8.

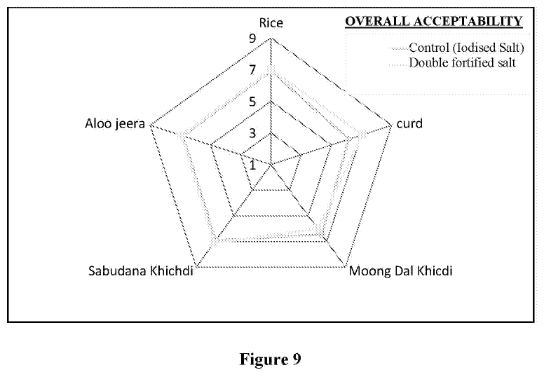

Acceptability: Over all acceptability rating of of inventive double fortified salt was found at par with that of control iodized salt. The result of preference test on the basis of acceptability is shown in FIG. 9.

### Specific Embodiments Are Described Below

A substantially encapsulated micronutrient granules for fortification of an edible salt composition, said encapsulated micronutrient granules comprising: granules comprising of 0.1 to 20% of at least one micronutrient and 1 to 99% of at least one binding agent selected from a group consisting of a fatty acid, cellulose derivative and sugar, encapsulated by an outer coating comprising of a fatty acid and cellulose derivative.

Such encapsulated micronutrient granules, wherein the outer coating comprises the fatty acid and cellulose derivative in a ratio ranging between 5:1 to 1:5.

Such encapsulated micronutrient granules, wherein the fatty acid is stearic acid.

Such encapsulated micronutrient granules, wherein the cellulose derivative is hydroxyl propyl methyl cellulose.

Such encapsulated micronutrient granules, having a particle size in a range of 200 to 800 microns.

Such encapsulated micronutrient granules, wherein the micronutrient is selected from a group consisting of Fe source, Zn source and mixtures thereof.

A fortified edible salt composition comprising:
98% of an edible salt;
0.1 to 5% of encapsulated micronutrient granules; and
0.01 to 0.5% of an additional micronutrient selected from a group consisting of potassium iodate, potassium iodide, and mixtures thereof.

A process for preparing substantially encapsulated micronutrient granules, the process comprising:
forming granules comprising of 0.1 to 20% of at least one micronutrient and 1 to 99% of at least one binding agent selected from a group consisting of a fatty acid, cellulose derivative and sugar; and
coating said granules with an outer coating comprising of fatty acid and cellulose derivative to obtain said encapsulated micronutrient granules.

Such process, wherein the outer coating comprises fatty acid and cellulose derivative in a ratio of 5:1 to 1:5.

Such process, wherein the fatty acid is stearic acid.

Such process, wherein the cellulose derivative is hydroxyl propyl methyl cellulose.

### INDUSTRIAL APPLICABILITY

The present disclosure provides a substantially encapsulated micronutrient granules for fortification of an edible salt composition. The disclosed substantially encapsulated micronutrient granules provides for effective fortification of edible salt with iron and zinc. The process can further be extended to encapsulate minerals such as copper, selenium etc.

Elaborate sensorial studies indicate that fortified edible salt composition obtained in accordance with an embodiment of the present invention does not impart any perceivable color and organoleptic changes such as metallic taste. The disclosed fortified edible salt composition when fortified with iron and iodine, retains iodine at satisfactory levels over a period of minimum 8 months while avoiding the problem of discolouration of said encapsulated micronutrient granules.

The disclosed process of preparing substantially encapsulated micronutrient granules is simple and inexpensive to perform.

1. Substantially encapsulated micronutrient granules for fortification of an edible salt composition, said encapsulated micronutrient granules comprising:
granules comprising 0.1 to 20% of at least one micronutrient and 1 to 99% of at least one binding agent selected from a group consisting a fatty acid, cellulose derivative and sugar, encapsulated by an outer coating comprising a fatty acid and cellulose derivative.

2. The encapsulated micronutrient granules as claimed in claim 1, wherein the outer coating comprises the fatty acid and cellulose derivative in a ratio ranging between 5:1 to 1:5.

3. The encapsulated micronutrient granules as claimed in claim 1, wherein the fatty acid is stearic acid.

4. The encapsulated micronutrient granules as claimed in claim 1, wherein the cellulose derivative is hydroxyl propyl methyl cellulose.

5. The encapsulated micronutrient granules as claimed in claim 1, having a particle size in a range of 200 to 800 microns.

6. The encapsulated micronutrient granules as claimed in claim 1, wherein the micronutrient is selected from a group consisting of Fe source, Zn source and mixtures thereof.

7. A fortified edible salt composition comprising:
98% of an edible salt;
0.1 to 5% of encapsulated micronutrient granules as claimed in claim 1; and
0.01 to 0.5% of an additional micronutrient selected from a group consisting of potassium iodate, potassium iodide, and mixtures thereof.

8. A process for preparing substantially encapsulated micronutrient granules, the process comprising:
forming granules comprising 0.1 to 20% of at least one micronutrient and 1 to 99% of at least one binding agent selected from a group consisting of a fatty acid, cellulose derivative and sugar; and
coating said granules with an outer coating comprising fatty acid and cellulose derivative to obtain said encapsulated micronutrient granules.

9. The process as claimed in claim 8, wherein the outer coating comprises the fatty acid and cellulose derivative in a ratio of 5:1 to 1:5.

10. The process as claimed in claim 8, wherein the fatty acid is stearic acid.

11. The process as claimed in claim 8, wherein the cellulose derivative is hydroxyl propyl methyl cellulose.

12. The encapsulated micronutrient granules as claimed in claim 2, wherein the fatty acid is stearic acid.

13. The encapsulated micronutrient granules as claimed in claim 2, wherein the cellulose derivative is hydroxyl propyl methyl cellulose.

14. The process as claimed in claim 9, wherein the fatty acid is stearic acid.

15. The process as claimed in claim 9, wherein the cellulose derivative is hydroxyl propyl methyl cellulose.
